(19) United States
(12) Patent Application Publication
(10) Pub. No.: US 2013/0052594 A1
(43) Pub. Date: Feb. 28, 2013

(54) MOTION PICTURE FILMS TO PROVIDE ARCHIVAL IMAGES

(71) Applicants: Diane M. Carroll-Yacoby, Honeoye Falls, NY (US); Christopher J. Haller, Rochester, NY (US); Paul L. Zengerle, Rochester, NY (US); Anabisdally Castro, Rochester, NY (US); Cynthia A. Fitzgerald, Rochester, NY (US)

(72) Inventors: Diane M. Carroll-Yacoby, Honeoye Falls, NY (US); Christopher J. Haller, Rochester, NY (US); Paul L. Zengerle, Rochester, NY (US); Anabisdally Castro, Rochester, NY (US); Cynthia A. Fitzgerald, Rochester, NY (US)

(21) Appl. No.: 13/222,201

(22) Filed: Aug. 31, 2011

(51) Int. Cl. G03C 7/32; G03C 7/26

(52) U.S. Cl. 430/363; 430/545; 430/496; 430/531; 430/383

(57) ABSTRACT

A silver halide motion picture film can be used to provide multicolor images for archival storage, exhibiting excellent dark stability as determined by Arrhenius testing. This motion picture film can be imaged using common digital recorders. The resulting multicolor image has a Dₘₐₓ in each color record of at least 2.3 Status A density. The overall contrast from each of the blue light sensitive color record, the red light sensitive color record, and the green light sensitive color record is the slope of a straight line connecting a point A and a point B on the characteristic curve of Status A density vs. log Exposure (E) for the respective color record, wherein point A is the log Exposure (E) required to attain a density level of 0.4 above Dₘᵢₙ and point B is the point represented by the log Exposure (E) of point A plus 0.7 log Exposure (E).

### FIELD OF THE INVENTION

This invention relates to photographic silver halide elements that are useful to provide motion picture films including color motion picture films that provide highly stable multicolor latent or visible images for archival purposes. This invention also provides a method of imaging and processing to obtain archival records of various images in film elements.

### BACKGROUND OF THE INVENTION

Many color silver halide photographic materials comprise a flexible transparent support with one or more coated layers on both sides, often referred to as an emulsion (imaging) side and the back (non-imaging) side. The back side generally has a conductive, antistatic layer and a scratch resistant top layer to facilitate film transport. The emulsion side generally has at least one layer sensitized to each of the three primary regions of the visible spectrum. They usually contain at least one blue-sensitive layer with a yellow image dye forming coupler, at least one green-sensitive layer with a magenta image dye forming coupler, and at least one red-sensitive layer with a cyan image dye forming coupler. Antihalation layers, interlayers, and a topcoat can also be present on the emulsion side.

There has been considerable effort in recent years to modify the composition and thickness of coated layers as much as possible in photographic materials, especially the silver halide emulsion light-sensitive layers, for various reasons, not the least of which are cost and modification of various sensitometric properties such as image contrast. Attempts are made to adjust the presence and concentrations of various photographic chemicals in the various silver halide emulsion light-sensitive layers to obtain desired properties. For example, image forming color couplers are changed or adjusted in concentration to change image contrast for each or all of the light sensitive color records.

Coupler solvents can be reduced to reduce gelatin coverage by using specific yellow or magenta minimum density dyes as described for example in U.S. Pat. Nos. 7,629,112 (Zengerle et al.) and 7,632,632 (Zengerle et al.). Thinning of the light-sensitive layers also can provide improved sharpness in the final photographic image due to reduced image scattering during exposure as described for example U.S. Pat. Nos. 5,891,613 (Zengerle et al.) and 6,544,724 (Satoh et al.). Improved abrasion resistance can also be obtained with reduced coupler solvent levels in the cyan imaging layers as described in U.S. Pat. No. 7,223,529 (Zengerle et al.). The use of specific alcoholic coupler solvents to increase coupler reactivity (for example cyan coupler reactivity) in order to minimize coated levels of silver halide, image coupler dispersion particles, and gelatin to lower material costs in color print motion picture films is described for example in U.S. Pat. No. 7,153,640 (Zengerle et al.).

Color motion picture films that can be used with digital output to provide high quality positive print images with defined contrast are described in U.S. Pat. Nos. 5,888,706 (Merrill et al.) and 5,891,607 (Brewer et al.).

Processes for inserting a digital image data manipulation step into conventional photographic image generation processes prior to making a final picture print as known in the art. Digital image data, obtained directly or by scanning optical (analog) images with a digital film scanner, can be easily manipulated using computer processing and look-up table mapping, before recording back out onto film elements. Special film-reproduction curves can be created to simulate any desired gamma (contrast), relative film speed (sensitivity) and toe or shoulder responses, and such curves can be implemented using custom look-up tables or computer software in film recorders. The reproduction response of digitally exposed films can be completely variable, unlike conventionally exposed films that have sensitometric responses that can be altered only slightly with changes in development time and temperature.

For many years, Kodak Vision Color Teleprint Film/2395™/3395™ was available to the marketplace. This motion picture film was useful for making low-contrast contact of optical prints from camera-original negatives, duplicate negatives, and internegatives. The film was optimized to produce low contrast positive images that closely match the dynamic range of telecine transfer mediums to produce excellent video images. In addition, this film was designed to provide excellent latent image stability as well as processed color image stability. To provide the images, the film comprised a transparent polyester substrate having coated thereon, in order, a blue light sensitive color record, a red light sensitive color record, a green light sensitive color record, and a surface non light sensitive protective overcoat. Further details of this film are described in “Kodak Vision Color Teleprint Film/2395™/3395™”, H-1-2395t, Eastman Kodak Company, September 1999, pages 1-8.

While the motion picture film industry has developed high quality motion picture origination films, motion picture intermediate films, and motion picture print films, the industry has a concern that images captured or stored in digital form may be damaged or lost for future generations. It is well known in the industry that captured digital content may have a limited life in whatever manner it is stored, and that digital content may not be convertible to future formats that may be incompatible with current formats.

The industry needs a way to keep both positive and negative images from various media formats in long-term storage. In other words, there is a need for protecting digital image assets that are currently in digital or optical form. It would be desirable to have a film for asset protection that has long term (for example, up to 100 years) image dye fade stability, that can be used in all major film recorders (including telecines and film scanners), and has wide latitude for original capture while being recordable onto film.

### SUMMARY OF THE INVENTION

The present invention provides a silver halide motion picture film comprising a transparent polymeric film substrate and further comprising, in order on and from one side of the polymeric film substrate;

a blue light sensitive color record comprising a blue light sensitive silver halide emulsion layer comprising a hydrophilic gelatin binder and a yellow dye image forming color coupler,

a red light sensitive color record comprising a red light sensitive silver halide emulsion layer comprising a hydrophilic gelatin binder and a cyan dye image forming color coupler,

a green light sensitive color record comprising a green light sensitive silver halide emulsion layer comprising a hydrophilic gelatin binder and a magenta dye image forming color coupler,

wherein upon imagewise exposure and processing, the three color records provide a multicolor image wherein:

(a) the overall contrast obtainable from each of the blue light sensitive color record, the red light sensitive color record, and the green light sensitive color record is the slope of a straight line connecting a point A and a point B on the characteristic curve of Status A density vs. log Exposure (E) for the respective color record, wherein point A is the log Exposure (E) required to attain a density level of 0.4 above Dₘᵢₙ and point B is the point represented by the log Exposure (E) of point A plus 0.7 log Exposure (E),

(b) the overall contrast obtainable from the green light sensitive color record is at least 1 and up to and including 3.5,

(c) the overall contrast obtainable from the blue light sensitive color record and the red light sensitive color record are the same or different and each is within ±12% of the overall contrast obtainable from the green light sensitive color record, and

(d) the Dₘₐₓ obtainable from the three color records are the same or different and at least 2.3 in Status A density.

In many embodiments, the silver halide motion picture film of this invention is further defined wherein:

e) a multicolor image is obtainable from the three color records independently have a Dₘₐₓ of at least 2.5 and up to and including 3.5 in Status A density,

f) the blue light sensitive color record comprises silver at a level of at least 200 mg/m² and up to and including 450 mg/m²,

g) the red light sensitive color record comprises silver at a level of at least 150 mg/m² and up to and including 375 mg/m²,

h) the green light sensitive color record comprises silver at a level of at least 225 mg/m² and up to and including 400 mg/m²,

i) the total silver level of all three color records are independently at least 575 mg/m² and up to and including 1200 mg/m², j) the bulk gelatin-to-junk ratios for each of the three color records are independently at least 1.5, and

k) the bulk gelatin-to-junk ratio for all of three color records is at least 1.5 and up to and including 3.

The present invention also provides a method of providing a color positive or color negative image comprising:

imagewise exposing the silver halide motion picture film of this invention using a motion picture film recorder having a laser, LED, or CRT light source to provide an exposed film with a latent color positive or negative image.

In many embodiments of this invention, the method further comprises processing the exposed film with the latent color positive or color negative image to form a multicolor image wherein:

(a) the overall contrast for the images obtained from each of the blue light sensitive color record, the red light sensitive color record, and the green light sensitive color record is the slope of a straight line connecting a point A and a point B on the characteristic curve of Status A density vs. log Exposure (E) for the respective color record, wherein point A is the log Exposure (E) required to attain a density level of 0.4 above Dₘᵢₙ and point B is the point represented by the log Exposure (E) of point A plus 0.7 log Exposure (E),

(b) the overall contrast of the image obtained from the green light sensitive color record is at least 1 and up to and including 3.5,

(c) the overall contrast of the image obtained from the blue light sensitive color record and the overall contrast of the image obtained from the red light sensitive color record are the same or different and each is within ±12% of the overall contrast of the image obtained from the green light sensitive color record, and

(d) the Dₘₐₓ of the images obtainable from the three color records are the same or different and at least 2.3 in Status A density.

The method of this invention can be used to provide a motion picture film having a color positive image wherein the motion picture film is provided as a film strip in either 16 or 35 mm format and has Bell and Howell perforations along each side of the film strip.

The silver halide motion picture films of this invention provide a number of advantages. They represent a relatively low cost way to record one or more color records onto a single strip of film for vault or ambient storage. Thus, because of their optimized dark stability, optical or digital images can be transferred and stored for at least 30 years and up to 100 years with less than 10% loss in image density. The silver halide motion picture films of this invention can also record color patches containing calibration data on the original media that is being archived. Moreover, the silver halide motion picture films of this invention have been optimized for telecine transfer and scanning.

### BRIEF DESCRIPTION OF THE DRAWINGS

FIG. 1 is a representative Density versus log H (contrast) plot for a standard sensitometric exposure of a motion picture film prepared in accordance with the present invention and illustrates how the overall contrast (OC) can be determined.

### DETAILED DESCRIPTION OF THE INVENTION

### Definitions

The term “junk”, is meant to refer to all organic materials incorporated into a given light-sensitive layer, or combination of light-sensitive layers, except the gelatin binder(s). These incorporated materials include but are not limited to, dye image forming color couplers, permanent coupler solvents, stabilizers, dyes, and oxidized developer scavengers. The silver halide grains are considered “junk” for this definition. The “junk” level for a given layer is calculated by adding the coated amounts of all light sensitive emulsions (in mg/m²) in the layer and dividing that number by three, and then adding together the coated levels of the organic compounds (other than gelatin) in the layer (in mg/m²) to arrive at the total “junk” level (in mg/m²) for that layer. In other words, the silver halide in the layer is considered ⅓ of the weight of all of the organic materials (other than gelatin) in the layer.

Unless otherwise noted, the terms “photographic element”, “photographic film”, “color photographic silver halide element”, “color motion picture print film”, “silver halide motion picture film”, and “multicolor photographic element” are intended to refer to the elements or embodiments of the present invention.

Unless otherwise specifically stated, use of the term “substituted” or “substituent” in defining the dyes means any group or atom other than hydrogen. Additionally, when the term “group” is used, it means that when a substituent group contains substitutable hydrogen, it is also intended to encompass not only the unsubstituted form of the substituent, but also its form further substituted with any other substituent group or groups as herein mentioned, so long as the substituent does not destroy properties necessary for photographic utility. Suitably, a substituent group can be halogen or can be bonded to the remainder of the molecule by an atom of carbon, silicon, oxygen, nitrogen, phosphorous, or sulfur. The substituent can be, for example, halogen (such as chlorine, bromine, or fluorine), nitro, hydroxyl, cyano, carboxyl, or groups which can be further substituted, such as alkyl, including straight or branched chain or cyclic alkyl, alkoxy, aryl, aryloxy, carbonamido, sulfonamide, sulfamoyl, carbamoyl, acyl, sulfonyl, sulfinyl, thio, acyloxy, amine, imino, phosphate, phosphite, a heterocyclic group, a heterocyclic oxy group or a heterocyclic thio group, each of which can be substituted and that contains a 3- to 7-membered heterocyclic ring composed of carbon atoms and at least one hetero atom selected from the group consisting of oxygen, nitrogen and sulfur.

If desired, the substituents can themselves be further substituted one or more times with the described substituent groups. The particular substituents used can be selected by those skilled in the art to attain the desired photographic properties for a specific application and can include, for example, hydrophobic groups, solubilizing groups, blocking groups, releasing or releasable groups, etc. When a molecule can have two or more substituents, the substituents can be joined together to form a ring such as a fused ring unless otherwise provided. Generally, the above groups and substituents thereof can include those having up to 48 carbon atoms, typically 1 to 36 carbon atoms and usually less than 24 carbon atoms, but greater numbers are possible depending on the particular substituents selected.

When the term “associated” is used, it signifies that a reactive compound is incorporated in or adjacent to a specified layer where, during processing, it is capable of reacting with other components.

The term “contrast” is well known in the photographic art to represent the slope of the characteristic Status A density versus log E (exposure) curve for a particular color record, and can be measured at any desired point on that curve.

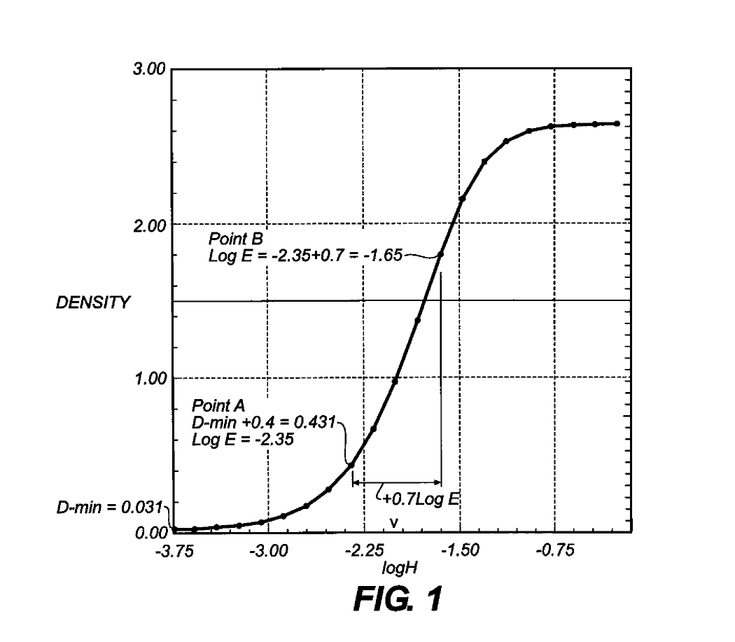

Overall contrast (OC) is the slope of a straight line connecting a point A and a point B on the characteristic curve of Status A density vs. log Exposure (E) for a color record. FIG. 1 shows a representative way to determined OC for a particular color record in the silver halide motion picture film of this invention.

Camera speed films are typically classified by an ISO speed rating, and these speed ratings are typically between 6 and 6400. The ISO formula used is as follows:

ISO=1/Hₘ times 0.8

wherein Hₘ is the exposure in lux-seconds that gives a density of 0.10 above the base plus fog and 0.8 is a constant that introduces a safety factor of 1.2 into the resulting speed value. The film is actually 1.2 times faster than the published value, which guards against underexposure. See Photographic Materials and Processes; editors Leslie Storbel, John Compton, Ira Current, Richard Zakia, Butterworth Publishers, Stoneham, Mass. (1986), p 55). The silver halide motion picture films of this invention generally have an ISO speed ratio of less than 10, typically less than 1, or even less than 0.5.

Haze values (%) can be determined by transmission measurements. A haze value (%) is defined as the scattered light divided by total transmitted light, times 100, as measured using a Gardner XL-211 Hazegard haze meter. The silver halide motion picture films of this invention generally have a haze value, when imaged and processed, of at least 2% and up to and including 5%.

Film perforations are holes cut in a regular sequence along one or both sides of a film strip, and can have any desired shape including but not limited to, circular, rectangular, and square, and can have suitably rounded corners and have any desired dimensions. Some common film perforations known as “BH” (Bell and Howell, or “N” negative) having straight top and bottom edges and outward curving sides, dimensions of 2.794 mm from the middle of the side curve to the opposite side by 1.854 mm in height and a pitch of 4.74 mm; “KS” (Kodak Standard, or “P” positive) having a rectangular base and rounded corners, dimensions of 1.981 mm high by 2.794 mm wide and a pitch of 4.75 mm; “DH” (Dubray having rectangular base with rounded corners, a width of 2.794 mm, and a height of 1.854 mm; and “CS” (CinemaScope or “fox hole”) that is nearly square in shape to provide space for four magnetic sound stripes, a width of 1.851 mm, and a height of 1.854 mm. For example, the silver halide motion picture film of this invention can be provided in the form of 16 mm or 35 mm film strip format and have Bell and Howell perforations along each side of the film strip. These perforations are generally put into the film strips during manufacture.

### Silver Halide Motion Picture Films

Upon imagewise exposure and processing (as described below), the silver halide motion picture film of this invention provides an image that exhibits dark stability at 10° C. greater than 20 years as determined by Arrhenius testing that is predictive of dark keeping image stability. In many embodiments, the silver halide motion picture film of this invention exhibits a dark stability at 10° C. greater than 50 years as determined by Arrhenius testing and up to 100 years under such conditions. Details about this testing are described in Journal of Imaging Science and Technology Vol. 37, pp. 363-373 (1993). This testing accomplishes accelerated dye image fading at high temperatures and extrapolates the results to predict the rate of image fading at lower storage temperatures. For the images produced in the silver halide motion picture films, the Arrhenius testing indicates less than 5% dye image loss after at least 20 years of storage at 10° C. and 50% relative humidity and generally less than 10% image loss after 50 years under the same conditions. The dye image loss can obviously vary under different storage conditions and time.

The silver halide motion picture films of this invention are multicolor imaging elements. Such multicolor elements contain image dye-forming color records sensitive to each of the three primary regions of the spectrum. Each color record can comprise one or more silver halide emulsion layers sensitive to a given region of the spectrum, but in most useful embodiments, there is a single silver halide emulsion layer responsive to appropriate radiation in each of the three color records. The layers of the elements, including the layers of the three color records are arranged in a specific order for color motion picture films, namely, the blue light sensitive color record (sensitized to about 380-500 nm) is closest to the support, followed by the red light sensitive color record (sensitized to about 600-760 nm), and then the green light color record (sensitized to about 500-600 nm).

Thus, a typical multicolor silver halide motion picture film of this invention element comprises a transparent polymeric film support bearing, in order, a blue light sensitive color record comprising a single blue light sensitive silver halide emulsion layer comprising a hydrophilic gelatin binder and a yellow dye image forming color coupler, a single red light sensitive color record comprising a red light sensitive silver halide emulsion layer comprising a hydrophilic gelatin binder and a cyan dye image forming color coupler, and a single green light sensitive color record comprising a green light sensitive silver halide emulsion layer comprising a hydrophilic gelatin binder and a magenta dye image forming color coupler. Each silver halide emulsion layer can have a mixture of different silver halide emulsions or mixtures of different silver halide grains in a single emulsion.

The overall contrast obtainable for the color image exhibited by each of the blue light sensitive color record, the red light sensitive color record, and the green light sensitive color record is the slope of a straight line connecting a point A and a point B on the characteristic curve of Status A density vs. log Exposure (E) for the respective color record, wherein point A is the log Exposure (E) required to attain a density level of 0.4 above Dₘᵢₙ and point B is the point represented by the log Exposure (E) of point A plus 0.7 log Exposure (E). In addition, the overall contrast obtainable from the green light sensitive color record is at least 1 and up to and including 3.5 (for example at least 2 and up to and including 3), the overall contrast obtainable from each of the blue light sensitive color record and the red light sensitive color record are the same or different and each is within ±12% (or typically ±9%) of the overall contrast obtainable from the green light sensitive color record, and the Dₘₐₓ values obtainable from each of the three color records are the same or different and at least 2.3 in Status A density.

In some embodiments, the silver halide motion picture film of this invention has the conditions:

e) the three color records can provide a color image having a Dₘₐₓ of at least 2.5 and up to and including 3.5 in Status A density,

f) the blue light sensitive color record comprises silver at a level of at least 200 mg/m² and up to and including 450 mg/m²,

g) the red light sensitive color record comprises silver at a level of at least 150 mg/m² and up to and including 375 mg/m²,

h) the green light sensitive color record comprises silver at a level of at least 225 mg/m² and up to and including 400 mg/m²,

i) the total silver level of all three color records are independently at least 575 mg/m² and up to and including 1225 mg/m²,

j) the bulk gelatin-to-junk ratios for the three color records are independently at least 1.5, and typically at least 1.7, and

k) the bulk gelatin-to-junk ratio for all of three color records is at least 1.5 and up to and including 3, or typically at least 1.5 and up to and including 2.5.

It is also useful that the OC obtainable from the green light sensitive color record of the silver halide motion picture film is at least 2 and up to and including 3. Moreover, the overall contrasts obtainable from each of the blue light sensitive color record and the red light sensitive color record are the same or different and each is within ±9% of the overall contrast obtainable from the green light sensitive color record.

The silver halide motion picture film can contain additional layers, such as filter layers, interlayers, outermost protective layers, and subbing layers on either or both sides of the transparent polymeric film support. For example, the silver halide motion picture film can further comprise a polymeric overcoat layer disposed as the outermost layer over the three color records. More details of the polymeric overcoat layer are provided below, but in general it can comprise one or more film-forming polymeric binders at a dry overcoat coverage of at least 6 mg/m² and up to and including 14 mg/m². This polymeric overcoat layer can also comprise a lubricant in an amount of at least 10 mg/m² and up to and including 30 mg/m².

The dye image forming color couplers are incorporated into the various color records so that during development, they are available in the color records to react with a color developing agent that is oxidized by silver halide image development. Non-diffusing image forming color couplers are usually incorporated into the layers. Color photographic chemistry can also be used to produce black-and-white images using a combination of non-diffusing image forming color couplers as described for example in WO 1993/012465 (Edwards et al.).

Some of the details about the chemistry used to construct the silver halide motion picture films of this invention and the principles for their use are described for example in James, The Theory of the Photographic Process, Chapter 12, Principles and Chemistry of Color Photography, pp. 335-372, 1977, Macmillian Publishing Co. (New York), Research Disclosure, December, 1997, Item 17643; November 1992, Item 34390; September 1994, Item 36544; September 1996, Item 38957, all published by Kenneth Mason Publications, Ltd., Dudley Annex, 12a North Street, Emsworth, Hampshire PO10 7DQ, ENGLAND.

The silver halide motion picture films of this invention generally comprise relatively small grain, high silver chloride emulsions, that is, emulsions having average grain size defined as cubic edge lengths (CEL) of less than 1 μm and a chloride content greater than 70 mol %, and typically a chloride content greater than 90 mol %, based on total silver in the emulsion, in each of the three color records. The silver halide grains can be the same or different in the three color records.

For example, each of the color records can comprise silver bromochloride grains comprising up to 20 mol % bromide (for example, at least 0.5 mol % and up to and including 2 mol %) based on silver, and silver iodochloride grains comprising up to 1 mol % iodide (for example at least 0.2 mol % and up to and including 0.6 mol %) based on silver. The types and amounts of each type of grains can be the same or different in the individual color records. When each color record has a single silver halide emulsion layer, each silver halide emulsion layer can have the same or different silver halide grains, or mixture of different silver halide grains. In general, such silver halide grains have cubic morphology with an edge length of at least 0.1 μm and up to and including 0.25 μm for the silver bromochloride grains and an edge length of at least 0.1 μm and up to and including 0.4 μm for the silver iodochloride grains.

The silver halide grains can be prepared according to methods known in the art, such as those described in Research Disclosure publications noted above and The Theory of the Photographic Process, 4^{th} edition, T. H. James, editor, Macmillan Publishing Co., New York, 1977. These include methods such as ammoniacal emulsion making, neutral or acidic emulsion making, and others known in the art. These methods generally involve mixing a water soluble silver salt with a water soluble halide salt in the presence of a protective colloid, and controlling the temperature, pAg, pH values, etc., at suitable values during formation of the silver halide by precipitation.

The silver halide grains in any of the color records can be “fine grain” emulsions. Such grains can take any regular shape such as cubic, octahedral, or cubo-octahedral (for example tetradecahedral) grains, or the grains can take other shapes attributable to ripening, twinning, and screw dislocations. Typically, the silver halide grains can be bounded primarily by {100} crystal faces since such grain faces are exceptionally stable. Specific examples of high silver chloride emulsions useful in the elements are described in U.S. Pat. Nos. 4,865,962, 5,252,454, 5,252,456, and 5,550,013, all of which are incorporated herein by reference.

In the course of grain precipitation one or more dopants (grain occlusions other than silver and halide) can be introduced to modify grain properties. For example, any of the various conventional dopants disclosed in Research Disclosure, Item 38957, Section I. Emulsion grains and their preparation, sub-section G. Grain modifying conditions and adjustments, paragraphs (3), (4) and (5), can be present in the emulsions. Especially useful dopants are disclosed by U.S. Pat. Nos. 4,937,180 (Machetti et al.), 5,164,292 (Johnson et al.), 5,597,686 (MacIntyre et al.), and 5,792,601 (Edwards et al.). In addition, it is possible to dope the grains with transition metal hexacoordination complexes containing one or more organic ligands as taught in U.S. Pat. No. 5,360,712 (Olm et al.).

Iridium dopants that are ineffective to provide shallow electron traps (non-SET dopants) can also be incorporated into the grains of the silver halide grain emulsions. The contrast of the images obtainable from the silver halide motion picture film can be further increased by doping the grains with a hexacoordination complex containing a nitrosyl or thionitrosyl ligand (NZ dopants) as disclosed in U.S. Pat. No. 4,933,272 (McDugle et al.).

In the following discussion of suitable materials for use in the present invention, reference will be made to Research Disclosure, September 1996, Item 38957, noted above, which will be identified hereafter by the term “Research Disclosure”. The contents of Research Disclosure, including the patents and publications referenced therein, are incorporated herein by reference, and the Sections hereafter referred to are Sections of Item 38957.

Suitable silver halide emulsions and their preparation as well as methods of chemical and spectral sensitization are described in Sections I through V. Various additives such as UV dyes, brighteners, antifoggants, stabilizers, light absorbing and scattering materials, and physical property modifying addenda such as hardeners, coating aids, plasticizers, lubricants and matting agents are described, for example, in Sections II and VI through VIII. Color materials are described in Sections X through XIII. Suitable methods for incorporating dye image-forming color couplers and dyes, including image-forming coupler dispersions in organic solvents, are described in Section X(E). Scan facilitating is described in Section XIV. Supports, exposure techniques, development systems, and processing methods and agents are described in Sections XV to XX.

The various layers of the silver halide motion picture films, and particularly the silver halide emulsion layers, contain one or more hydrophilic gelatin or gelatin derivatives as vehicles and binders. The term “gelatin” is used herein to refer to gelatin and gelatin derivatives that can be naturally occurring or of synthetic origin, and include but are not limited to, phthalated gelatin, alkaline gelatin, acidified gelatin, carboxylated gelatin, recombinant gelatins, and any chemically modified gelatins. Mixtures of gelatins can be used in any of the layers of the silver halide motion picture films.

It is also contemplated that the materials and processes described in Research Disclosure February 1995, Item 37038 also can be advantageously used in and with the silver halide motion picture films of this invention.

The following discussion relates to dye image forming color couplers (“couplers”) used in the present invention. Coupling-off groups can determine the chemical equivalency of a coupler, i.e., whether it is a 2-equivalent or a 4-equivalent coupler, or modify the reactivity of the coupler. Such groups can advantageously affect the layer in which the dye image-forming color coupler is located, or other layers in the silver halide motion picture film, by performing, after release from the coupler, functions such as dye formation, dye hue adjustment, development acceleration or inhibition, bleach acceleration or inhibition, electron transfer facilitation, or color correction.

The presence of hydrogen at the coupling site provides a 4-equivalent coupler, and the presence of another coupling-off group usually provides a 2-equivalent coupler. Representative classes of such coupling-off groups include, for example, chloro, alkoxy, aryloxy, hetero-oxy, sulfonyloxy, acyloxy, acyl, heterocyclyl such as oxazolidinyl or hydantoinyl, sulfonamido, mercaptotetrazole, benzothiazole, mercaptopropionic acid, phosphonyloxy, arylthio, and arylazo. These coupling-off groups are described in the art, for example, in U.S. Pat. Nos. 2,455,169, 3,227,551, 3,432,521, 3,476,563, 3,617,291, 3,880,661, 4,052,212 and 4,134,766, and in GB published applications 1,466,728, 1,531,927, 1,533,039, 2,006,755A and 2,017,704A, the disclosures of which are incorporated herein by reference.

Dye image forming color couplers that form cyan dyes upon reaction with oxidized color developing agents are described for example, in U.S. Pat. Nos. 2,367,531, 2,423,730, 2,474,293, 2,772,162, 2,895,826, 3,002,836, 3,034,892, 3,041,236, 4,333,999, 4,883,746, and 5,256,526 and “Farbkuppler-eine LiteratureUbersicht,” published in Agfa Mitteilungen, Band III, pp. 156-175 (1961). Usually such dye image-forming color couplers are phenols, naphthols, and pyrazolotriazoles that form cyan dyes on reaction with oxidized color developing agent. Other useful cyan dye image-forming color couplers are described in U.S. Pat. No. 7,153,640 (Zengerle al.) that is incorporated herein by reference.

Dye image forming color couplers that form magenta dyes upon reaction with oxidized color developing agent are described in U.S. Pat. Nos. 2,311,082, 2,343,703, 2,369,489, 2,600,788, 2,908,573, 3,062,653, 3,152,896, 3,519,429, 3,758,309, and 4,540,654, and “Farbkuppler-eine LiteratureUbersicht,” published in Agfa Mitteilungen, Band III, pp. 126-156 (1961). Usually such dye image forming color couplers are pyrazolones, pyrazolotriazoles, or pyrazolobenzimidazoles that form magenta dyes upon reaction with oxidized color developing agents.

Dye image forming color couplers that form yellow dyes upon reaction with oxidized and color developing agent are described in U.S. Pat. Nos. 2,298,443, 2,407,210, 2,875,057, 3,048,194, 3,265,506, 3,447,928, 4,022,620, 4,443,536, 4,840,884, 5,447,819, 5,457,004, 5,998,121, 6,132,944, and 6,569,612, and “Farbkuppler-eine LiteratureUbersicht,” published in Agfa Mitteilungen, Band III, pp. 112-126 (1961). Such dye image forming color couplers are typically open chain ketomethylene compounds.

Dye image forming color couplers that form colorless products upon reaction with oxidized color developing agent are described in GB Patent 861,138 and U.S. Pat. Nos. 3,632,345, 3,928,041, 3,958,993, and 3,961,959.

Typically such dye image forming color couplers are cyclic carbonyl containing compounds that form colorless products on reaction with an oxidized color developing agent.

Dye image forming color couplers that form black dyes upon reaction with oxidized color developing agent are described in U.S. Pat. Nos. 1,939,231, 2,181,944, 2,333,106, and 4,126,461, German OLS Nos. 2,644,194 and 2,650,764. Typically, such dye image-forming color couplers are resorcinols or m-aminophenols that form black or neutral products on reaction with oxidized color developing agent.

In addition to the foregoing, so-called “universal” or “washout” couplers can be employed. These couplers do not contribute to image dye-formation. Thus, for example, a naphthol having an unsubstituted carbamoyl or one substituted with a low molecular weight substituent at the 2- or 3-position can be employed. Couplers of this type are described, for example, in U.S. Pat. Nos. 5,026,628, 5,151,343, and 5,234,800.

It can be useful to use a combination of dye image forming color couplers, any of which can contain known ballasts or coupling-off groups such as those described in U.S. Pat. Nos. 4,301,235, 4,853,319, and 4,351,897. The dye image forming color coupler can contain solubilizing groups such as those described in U.S. Pat. No. 4,482,629. The dye image forming color coupler can also be used in association with “wrong” colored couplers (for example, to adjust levels of interlayer correction) and, in color negative applications, with masking couplers such as those described in EP 213,490, Japanese Published Applications 58-172,647 and 58-113935, U.S. Pat. Nos. 2,983,608, 4,070,191, and 4,273,861, German Applications DE 2,706,117 and 2,643,965, and GB Patent Publication 1,530,272. The masking couplers can be shifted or blocked, if desired.

Typically, dye image forming color couplers are incorporated into a silver halide light sensitive emulsion layer in a mole ratio to silver of at least 0.05:1 and up to and including 1:1, or typically at least 0.1:1 and up to and including 0.5:1. Usually the dye image forming color couplers are incorporated as dispersions in one or more hydrophobic organic solvents (sometimes called “permanent” solvents or coupler solvents), such as one or more high-boiling organic solvents, in a weight ratio of organic solvent to image forming coupler of at least 0.1:1 and up to and including 10:1, and typically of at least 0.1:1 and up to and including 2:1 although dispersions using no organic solvent are sometimes employed.

A dye image forming color coupler dispersion contains a dye image forming color coupler in a stable, finely divided state in a hydrophobic organic solvent that is stabilized by suitable surfactants or surface active agents usually in combination with a binder or matrix such as a gelatin. The dispersion can contain one or more hydrophobic organic solvents that dissolve the materials and maintain them in a liquid state. Some examples of suitable hydrophobic organic solvents are tricresylphosphate, N,N-diethyllauramide, N,N-dibutyllauramide, p-dodecylphenol, dibutylphthalate, di-n-butyl sebacate, N-n-butylacetanilide, 9-octadecen-1-ol, ortho-methylphenyl benzoate, trioctylamine and 2-ethylhexylphosphate. Useful classes of solvents are carbonamides, phosphates, phenols, alcohols, and esters. When a hydrophobic organic solvent is 1.5 present, it is usual that the weight ratio of coupler to organic solvent be at least 1:0.5, or at least 1:1. The dispersion can contain an auxiliary coupler solvent initially to dissolve the coupler but this solvent is removed afterwards, usually either by evaporation or by washing with additional water. Some examples of suitable auxiliary coupler solvents are ethyl acetate, cyclohexanone and 2-(2-butoxyethoxy)ethyl acetate. The dispersion can also be stabilized by addition of polymeric materials to form stable latexes. Examples of suitable polymers for this use generally contain water-solubilizing groups or have regions of high hydrophilicity. Some examples of suitable dispersing agents or surfactants are Alkanol XC, sodium dodecyl benzene sulfonate, and saponin. The dye image forming color couplers can also be dispersed as an admixture with another component of the system such as a dye image forming color coupler or an oxidized developer scavenger so that both are present in the same oil droplet. It is also possible to incorporate the dye image forming color couplers as a solid particle dispersion; that is, a slurry or suspension of finely ground (through mechanical means) compound. These solid particle dispersions can be additionally stabilized with surfactants or polymeric materials as known in the art. Also, additional coupler solvents can be added to the solid particle dispersion to help increase activity.

The term “high boiling organic solvent” is used herein to refer to coupler solvents having a boiling point above about 150° C. Such coupler solvents have sufficient carbon atoms so that they have a sufficient molecular weight to prevent excessive solvent migration between layers in the element. The coupler solvents are also liquids at 37° C. that is a typical processing (development) temperature. Particularly useful high boiling organic solvents include tricresylphosphate, N,N-diethyllauramide, N,N-dibutyllauramide, p-dodecylphenol, dibutylphthalate, di-n-butyl sebacate, 2-hexyl-1-decanol, tri(2-ethylhexyl)phosphate, 2,4-di-t-pentylphenol, and triphenylphosphate.

Embodiments of the silver halide motion picture film of this invention can also exhibit advantages in view of the fact that the bulk gelatin-to-junk ratio for the total three color records is greater than 1.5 or typically greater than 1.7. The bulk gelatin-to-junk weight ratio is defined by the following equation:

Bulk gelatin-to-junk ratio=[(B_{gel}×B_{gel/junk})+(R_{gel}×R_{gel/junk})+(G_{gel}+G_{gel/junk})]÷(B_{gel}+R_{gel}+G_{gel}).

wherein B_{gel} is the total gelatin level for all the blue light sensitive silver halide layers in the blue light sensitive color record layers, B_{gel/junk} is the gelatin-to-junk ratio for all blue light sensitive silver halide layers, R_{gel} is the total gelatin level for all red light sensitive silver halide layers in the red light sensitive color record, R_{gel/junk} is the gelatin-to-junk ratio for all red light sensitive silver halide layers, G_{gel} is the total gelatin level for all green light sensitive silver halide layers in the green light sensitive color record, and G_{gel/junk} is the gelatin-to-junk ratio for all green light sensitive silver halide layers. In addition, the total gelatin level on the imaging side of the support is less than 15,000 mg/m², or at least 5,000 mg/m² and up to and including 12,000 mg/m².

The bulk gelatin-to-junk ratio for each of the three color records is independently at least 1.5 and up to and including 3. The bulk gelatin-to-junk ratio for each given color record is determined using the following representative equation that is shown, for example, for the blue color record:

Bulk gelatin-to-junk ratio for blue color record=[(B_{gel}×B_{gel/junk})]÷(B_{gel}).

In general, the blue light sensitive color record comprises silver at a level of at least 200 mg/m² and up to and including 450 mg/m², or typically at least 250 mg/m² and up to and including 400 mg/m².

In general, the red light sensitive color record comprises silver at a level of at least 150 mg/m² and up to and including 375 mg/m², or typically at least 225 mg/m² and up to and including 400 mg/m².

In general, the green light sensitive color record comprises silver at a level of at least 250 mg/m² and up to and including 400 mg/m², or typically at least 275 mg/m² and up to and including 375 mg/m².

The silver halide motion picture films can include materials that accelerate or otherwise modify the processing steps e.g. of bleaching or fixing to improve the quality of the image. Bleach accelerator releasing couplers such as those described in EP 193,389 and 301,477, and U.S. Pat. Nos. 4,163,669, 4,865,956, and 4,923,784, can be useful. Also contemplated is the use of compositions in association with nucleating agents, development accelerators or their precursors (GB Patents 2,097,140 and 2,131,188), electron transfer agents (U.S. Pat. Nos. 4,859,578 and 4,912,025), antifogging and anti-color-mixing agents such as derivatives of hydroquinones, aminophenols, amines, gallic acid, catechol, ascorbic acid, hydrazides, sulfonamidophenols, and non color-forming couplers.

The silver halide motion picture films can also include filter dye layers comprising colloidal silver sol or yellow, cyan, or magenta filter dyes, either as oil-in-water dispersions, latex dispersions or as solid particle dispersions. Additionally, they can be used with “smearing” couplers (as described in U.S. Pat. Nos. 4,366,237, 4,420,556, and 4,543,323 and EP 96,570).

A compound such as a dye image-forming color coupler can release a PUG directly upon reaction of the compound during processing, or indirectly through timing or linking groups. A timing group produces the time-delayed release of the PUG such groups using an intramolecular nucleophilic substitution reaction (U.S. Pat. No. 4,248,962); groups utilizing an electron transfer reaction along a conjugated system (see U.S. Pat. Nos. 4,409,323, 4,421,845, and 4,861,701, Japanese Published Patent Applications 57-188035; 58-98728; 58-209736; and 58-209738); groups that function as a coupler or reducing agent after the coupler reaction (U.S. Pat. Nos. 4,438,193 and 4,618,571) and groups that combine the features described above.

Moreover, speed enhancing materials such as those described in U.S. Pat. Nos. 6,455,242, 6,426,180, 6,350,564, and 6,319,660 can be used. Unless indicated otherwise, compounds used directly in a silver halide motion picture film can be added to a mixture containing silver halide before coating or, more suitably, be mixed with the silver halide just prior to or during coating. In either case, additional components like dye image forming color couplers, doctors, surfactants, hardeners, and other materials that are typically present in such solutions can also be present at the same time.

### Imaging and Development

The silver halide motion picture films of this invention can be exposed to imaging radiation from any suitable source that is known in the art. It is particularly useful that the silver halide motion picture film is imagewise exposed using a motion picture film recorder having a laser, LED, or CRT light source to provide an exposed film with a latent color positive or color negative image. The imagewise exposed film can then be processed to form a visible positive or negative dye image. Often, the latent image is produced from digital data obtained by scanning other images including images on video tape, compact discs, originating motion picture film, intermediate motion picture film, and motion picture print film.

The imaged silver halide motion picture film can be processed to form a visible color positive or color negative dye image by contacting it with a suitable color developing agent to reduce developable silver halide and oxidize the color developing agent. Oxidized color developing agent in turn reacts with the dye image forming color coupler(s) to yield dye images. The color processing sequence is typically used to form a developed color image having a Dₘₐₓ of at least 2.3 in each of the three color records.

In some embodiments, the imagewise exposed motion picture film can be used to provide a positive image using a process such as the Kodak ECP-2D process described in the H-24.09 Manual for Processing Eastman Color films, which is available from Eastman Kodak Company. For example, useful color developing agents are p-phenylenediamines such as 4-amino-N,N-diethylaniline hydrochloride, 4-amino-3-methyl-N,N-diethylaniline hydrochloride, 4-amino-3-methyl-N-ethyl-N-(2-methanesulfonamidoethyl)aniline sesquisulfate hydrate, 4-amino-3-methyl-N-ethyl-N-(2-hydroxyethyl)aniline sulfate, 4-amino-3-(2-methanesulfonamidoethyl)-N,N-diethylaniline hydrochloride and 4-amino-N-ethyl-N-(2-methoxyethyl)-m-toluidine di-p-toluene sulfonic acid.

Development is usually followed by the conventional steps of bleaching, fixing, or bleach-fixing, to remove silver or silver halide, washing, and drying. The details for processing are well known in the art, and Invention Example 1 below provides representative processing chemistry and conditions for practicing the present invention.

The resulting imaged motion picture films can further comprise a digital or optical sound track that was added to the motion picture film before or after imagewise exposure and processing.

In addition, the silver halide motion picture films of this invention can be imaged and processed to include data in “color patches” provided on original films or media. As is known in the art, such color patches, exposed at the same time as the original image(s) can be used for future image restoration since their original data (code values) are known.

As noted above, the resulting imaged motion picture films can have multicolor images having a green light sensitive color record overall contrast of at least 2 and up to and including 3, the blue light sensitive color record exhibits an overall contrast of at least 2 and up to and including 3 and the red light sensitive color record exhibits an overall contrast of at least 2 and up to and including 3.

The following Invention Example is provided to illustrate the practice of this invention and is not meant to be limiting in any manner.

### Invention Example

A silver halide motion picture film of this invention was prepared by coating the following multilayer film structure, in order (Layer 1 closest to the support), on a transparent poly(ethylene terephthalate) support having an antistatic layer and a polyurethane protective layer coated on the back side of the support.

| Layer 1: | mg/m² |
|---|---|
| Dye-1 | 85.8 |
| Dye-2 | 67.0 |
| Gelatin | 659 |

| Layer 2: | mg/m² |
|---|---|
| Blue-sensitive emulsion 1 | 25.5 |
| (3D 0.34 μm, AgCl_{.995}I_{.005}, having sensitizing Dye-1 | |
| and sensitizing Dye-2) | |
| Blue-sensitive emulsion 2 | 199.9 |
| (3D 0.24 μm, AgCl_{.995}I_{.005}, having sensitizing Dye-1 | |
| and sensitizing Dye-2) | |
| Blue-sensitive emulsion 3 | 114.6 |
| (3D 0.27 μm, AgCl_{.996}Br_{.004}, having sensitizing dye-1 | |
| and sensitizing dye-2) | |
| Coupler Y-1 | 1014 |
| Dye-3 | 20.0 |
| Dye-4 | 20.0 |
| Dye-5 | 13.0 |
| Chem-1 | 2.0 |
| CS-1 | 3.0 |
| CS-3 | 28.0 |
| Gelatin | 2266 |

| Layer 3: | mg/m² |
|---|---|
| Chem-1 | 15.0 |
| CS-1 | 22.5 |
| Gelatin | 800 |

| Layer 4: | mg/m² |
|---|---|
| Red-sensitive emulsion 1 | 27.2 |
| (3D 0.22 μm, AgCl_{.991}Br_{.009}, having sensitizing | |
| Dye-3) | |
| Red-sensitive emulsion 2 | 119.3 |
| (3D 0.15 μm, AgCl_{.991}Br_{.009}, having sensitizing | |
| Dye-3) | |
| Red-sensitive emulsion 3 | 155.5 |
| (3D 0.12 μm, AgCl_{.990}Br_{.010}, having sensitizing | |
| Dye-3) | |
| Coupler C-1 | 670.0 |
| CS-1 | 335.0 |
| CS-3 | 335.0 |
| Dye-6 | 17.0 |
| Gelatin | 2550 |

| Layer 5: | mg/m² |
|---|---|
| Chem-1 | 15.0 |
| CS-1 | 22.5 |
| CS-3 | 47.0 |
| Gelatin | 470 |

| Layer 6: | mg/m² |
|---|---|
| Green-sensitive emulsion 1 | 29.4 |
| (3D 0.22 μm, AgCl_{.987}Br_{.013}, having sensitizing Dye-4 | |
| and sensitizing Dye-5) | |
| Green-sensitive emulsion 2 | 223.4 |
| (3D 0.15 μm, AgCl_{.987}Br_{.013}, having sensitizing Dye-4 | |
| and sensitizing Dye-5) | |
| Green-sensitive emulsion 3 | 73.4 |
| (3D 0.12 μm, AgCl_{.982}Br_{.018}, having sensitizing Dye-4 | |
| and sensitizing Dye-5) | |
| Coupler M-1 | 430 |
| CS-2 | 86.0 |
| Chem-1 | 2.0 |
| CS-1 | 3.0 |
| Dye-7 | 24.0 |
| Gelatin | 1087 |

| Layer 7: | mg/m² |
|---|---|
| Polydimethylsiloxane | 10.0 |
| Carnauba wax | 20.0 |
| Gelatin | 700 |

The above coatings further contained sequestering agents, antifoggants, surfactants, antistatic agent, and matte beads as are known in the art, and hardener at 1.49% of total gelatin.

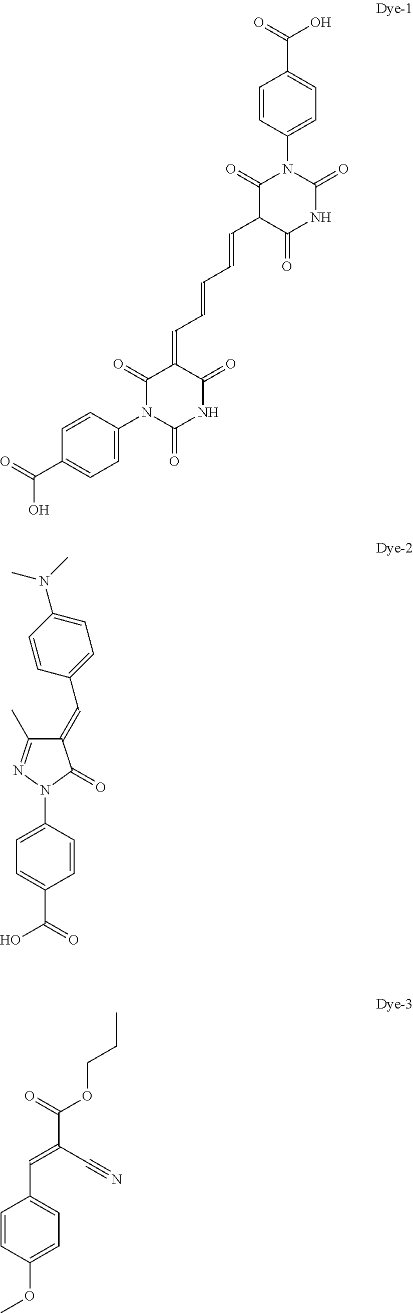 [SMILES: O=C1NC(=O)N(c2ccc(C(=O)O)cc2)C(=O)/C1=C/C=C/C=C/C1C(=O)NC(=O)N(c2ccc(C(=O)O)cc2)C1=O ; CC1=NN(c2ccc(C(=O)O)cc2)C(=O)/C1=C/c1ccc(N(C)C)cc1 ; CCCOC(=O)/C(C#N)=C/c1ccc(OC)cc1]

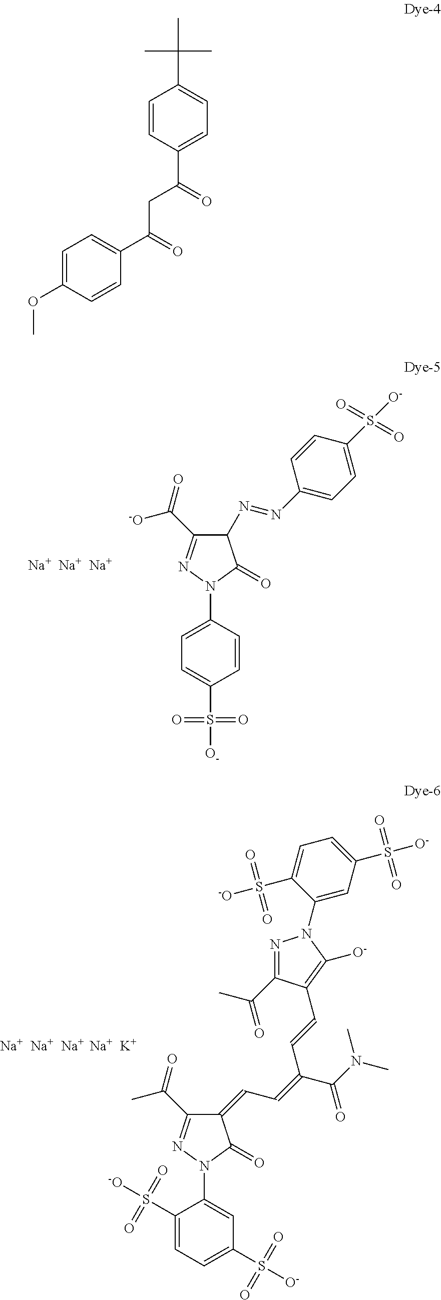

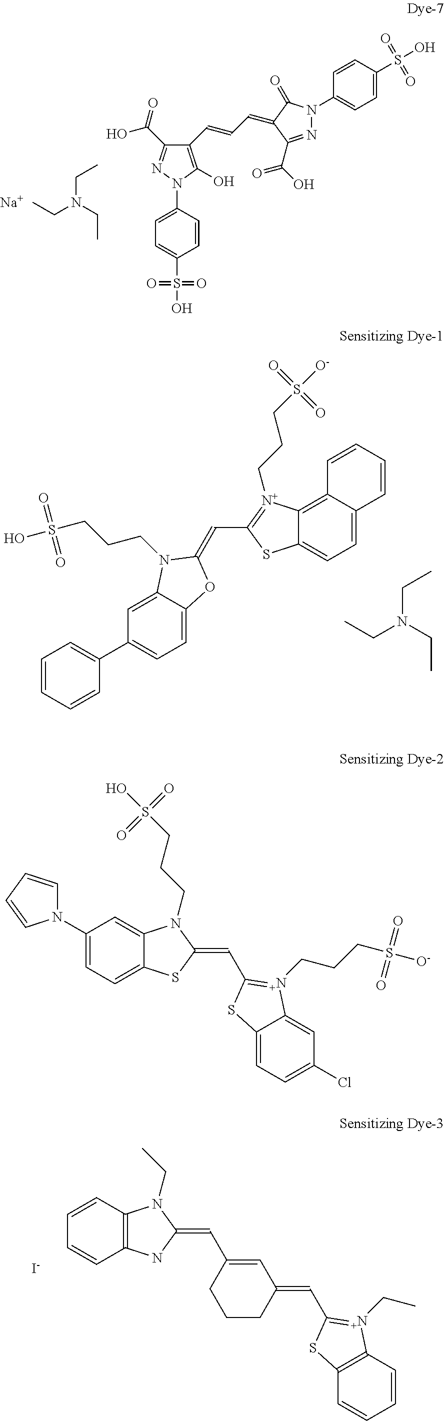

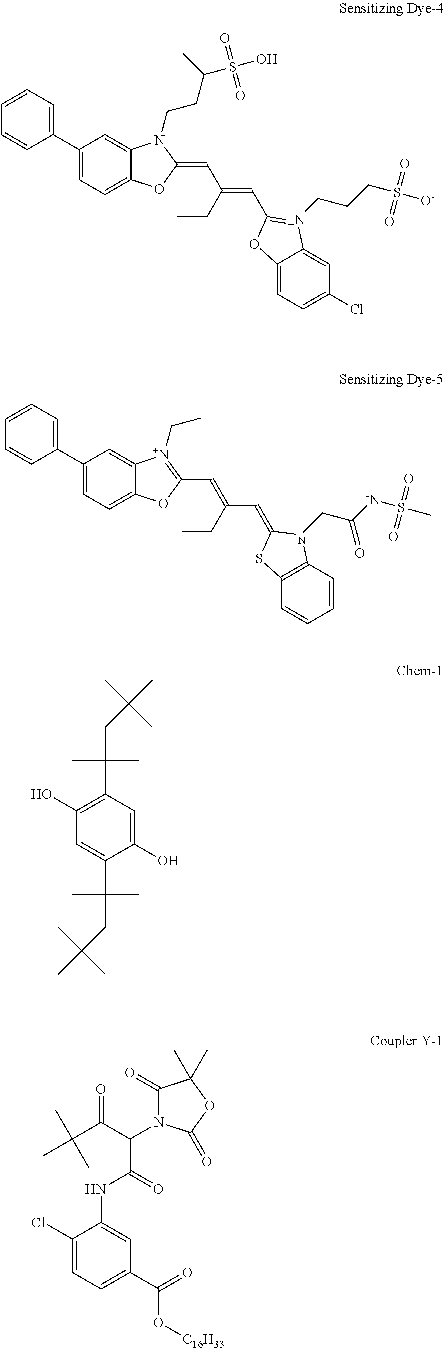

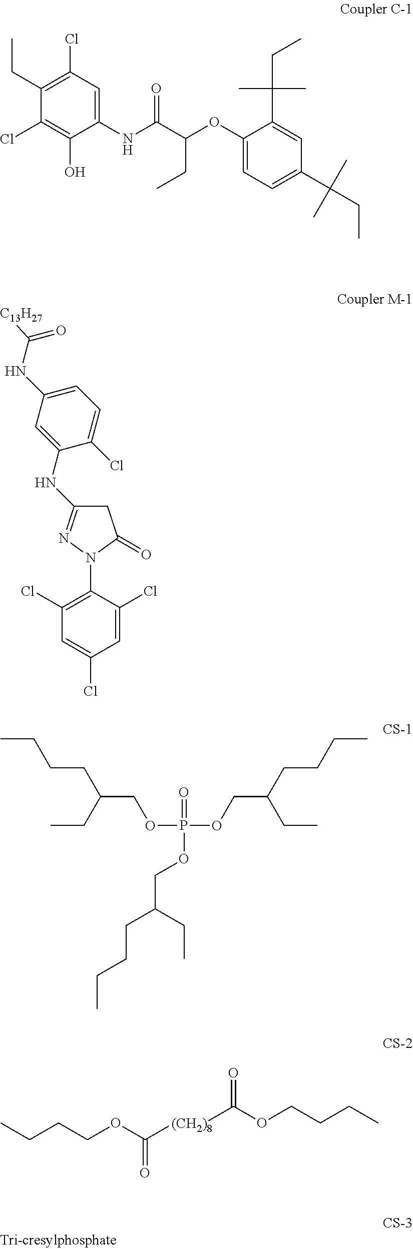

The resulting silver halide motion picture film was exposed through a 0-3 neutral density 21-step tablet on a Kodak 1B sensitometer with a 3200K light source. After exposure, the films were processed according to the standard Kodak ECP-2 Color Print Development Process (known in the art as the “ECP” process) as described in the Kodak H-24 Manual, “Manual for Processing Eastman Color Motion Picture Films”, Eastman Kodak Company, Rochester, N.Y., the disclosure of which is incorporated by reference herein, except that the color development time was shortened from 3 minutes to 60 seconds. The process consisted of a pre-bath (10 seconds), water rinse (20 seconds), color developer (60 seconds), stop bath (40 seconds), first wash (40 seconds), first fix (40 seconds), second wash (40 seconds), bleach (1 minute), third wash (40 seconds), second fix (40 seconds), fourth wash (1 second), final rinse (10 seconds), and then drying with hot air.

### The ECP-2 Prebath:

| | | |
|---|---|---|
| Water | 800 | ml |
| Borax (decahydrate) | 20.0 | g |
| Sodium sulfate (anhydrous) | 100.0 | g |
| Sodium hydroxide | 1.0 | g |

Water to make 1 liter
pH = 9.25 +/− 0.10 @ 26.7° C.

### The ECP-2 Color Developer:

| | |
|---|---|
| Water | 900 ml |
| Kodak Anti-Calcium, No. 4 | 1.00 ml |
| (40% solution of a pentasodium salt of nitrilo-trimethylene | |
| phosphonic acid) | |
| Sodium sulfite (anhydrous) | 4.35 g |
| Sodium bromide (anhydrous) | 1.72 g |
| Sodium carbonate (anhydrous) | 17.1 g |
| Kodak Color Developing Agent, CD-2 | 2.95 g |
| Sulfuric acid (7.0N) | 0.62 ml |

Water to make 1 liter
pH = 10.53 +/− 0.05 @ 26.7° C.

### The ECP-2 Stan Bath:

| | |
|---|---|
| Water | 900 ml |
| Sulfuric acid (7.0N) | 50.0 ml |

Water to make 1 liter
pH = 0.90 @ 26.7° C.

### The ECP-2 Fixer:

| | | |
|---|---|---|
| Water | 800 | ml |
| Ammonium thiosulfate (58.0% solution) | 100.0 | ml |
| Sodium bisulfate (anhydrous) | 13.0 | g |

Water to make 1 liter
pH = 5.00 +/− 0.15 @ 26.7° C.

### The ECP-2 Ferricyanide Bleach:

| | |
|---|---|
| Water | 900 ml |
| Potassium ferricyanide | 30.0 g |
| Sodium bromide (anhydrous) | 17.0 g |

Water to make 1 liter
pH = 6.50 +/− 0.05 @ 26.7° C.

### The ECP-2 Final Rinse:

| | |
|---|---|
| Water | 900 ml |
| Kodak Photo-Flo 200 ™ Solution | 3.0 ml |

Water to make 1 liter

Processing of the exposed films was carried out using the color developing solution adjusted to 36.7° C. The stopping, fixing, bleaching, washing, and final rinsing solution temperatures were adjusted to 26.7° C.

The optical density due to dye formation was then measured on a densitometer using Status A filters in the densitometer. Dye density was then graphed versus log(exposure) to form the Red, Green, and Blue D-log E characteristic curves of the photographic films. The overall contrasts and maximum density values for each color record obtained from these coatings are given below in TABLE I.

TABLE I

| Parameter | Red | Green | Blue |
|---|---|---|---|
| Overall Contrast | 2.53 | 2.39 | 2.19 |
| Dmax | 2.45 | 2.63 | 2.55 |

These results clearly illustrate that the silver halide motion picture film described above provides results that satisfy the requirements for this particular application.

The invention has been described in detail with particular reference to certain preferred embodiments thereof, but it will be understood that variations and modifications can be effected within the spirit and scope of the invention.

1. A silver halide motion picture film comprising a transparent polymeric film substrate and further comprising, in order on and from one side of the polymeric film substrate:
a blue light sensitive color record comprising a blue light sensitive silver halide emulsion layer comprising a hydrophilic gelatin binder and a yellow dye image forming color coupler,
a red light sensitive color record comprising a red light sensitive silver halide emulsion layer comprising a hydrophilic gelatin binder and a cyan dye image forming color coupler,
a green light sensitive color record comprising a green light sensitive silver halide emulsion layer comprising a hydrophilic gelatin binder and a magenta dye image forming color coupler,
wherein upon imagewise exposure and processing, the three color records provide a multicolor image wherein:
(a) the overall contrast obtainable from each of the blue light sensitive color record, the red light sensitive color record, and the green light sensitive color record is the slope of a straight line connecting a point A and a point B on the characteristic curve of Status A density vs. log Exposure (E) for the respective color record, wherein point A is the log Exposure (E) required to attain a density level of 0.4 above Dₘᵢₙ and point B is the point represented by the log Exposure (E) of point A plus 0.7 log Exposure (E),
(b) the overall contrast obtainable from the green light sensitive color record is at least 1 and up to and including 3.5,
(c) the overall contrast obtainable from the blue light sensitive color record and the red light sensitive color record are the same or different and each is within ±12% of the overall contrast obtainable from the green light sensitive color record, and
(d) the Dₘₐₓ obtainable from the three color records are the same or different and at least 2.3 in Status A density.

2. The silver halide motion picture film of claim 1 comprising a single blue light sensitive silver halide emulsion layer, a single red light sensitive silver halide emulsion layer, and a single green light sensitive silver halide emulsion layer, in the respective records.

3. The silver halide motion picture film of claim 1 that is in the form of a 16 mm or 35 mm film strip format that has Bell and Howell perforations along each side of the film strip.

4. The silver halide motion picture film of claim 1 that upon imagewise exposure and processing, provides a multicolor image that exhibits dark stability at 10° C. greater than 20 years as determined by Arrhenius testing.

5. The silver halide motion picture film of claim 1 that upon imagewise exposure and processing, provides a multicolor image that exhibits dark stability at 10° C. greater than 50 years as determined by Arrhenius testing.

6. The silver halide motion picture film of claim 1 that upon imagewise exposure and processing, provides a multicolor image having a haze value of at least 2 and up to and including 5.

7. The silver halide motion picture film of claim 1 having an ISO speed ratio of less than 10.

8. The silver halide motion picture film of claim 1 wherein:
e) a multicolor image is obtainable from the three color records independently have a Dₘₐₓ of at least 2.5 and up to and including 3.5 in Status A density,
f) the blue light sensitive color record comprises silver at a level of at least 200 mg/m² and up to and including 450 mg/m²,
g) the red light sensitive color record comprises silver at a level of at least 150 mg/m² and up to and including 375 mg/m²,
h) the green light sensitive color record comprises silver at a level of at least 225 mg/m² and up to and including 400 mg/m²,
i) the total silver level of all three color records are independently at least 575 mg/m² and up to and including 1200 mg/m²,
j) the bulk gelatin-to-junk ratios for each of the three color records are independently at least 1.5, and
k) the bulk gelatin-to-junk ratio for all of three color records is at least 1.5 and up to and including 3.

9. The silver halide motion picture film of claim 1 further comprising a polymeric overcoat layer disposed as the outermost layer over the three color records, the polymeric overcoat layer comprising a film-forming polymeric binder that is present at a dry coverage of at least 6 mg/m² and up to and including 14 mg/m², and the overcoat layer optionally further comprises a lubricant in an amount of at least 10 mg/m² and up to and including 30 mg/m².

10. The silver halide motion picture film of claim 1 further comprising a digital or optical sound track recording portion.

11. The silver halide motion picture film of claim 1 wherein the overall contrast obtainable from the green light sensitive color record is at least 2 and up to and including 3.

12. The silver halide motion picture film of claim 1 wherein the overall contrast obtainable from the blue light sensitive color record and the overall contrast obtainable from the red light sensitive color record are the same or different and each obtainable overall contrast is within ±9% of the overall contrast obtainable from the green light sensitive color record.

13. The silver halide motion picture film of claim 1 wherein each of the color records comprises silver bromochloride grains comprising up to 20 mol % bromide based on silver, and silver iodochloride grains comprising up to 1 mol % iodide based on silver.

14. A method of providing a color positive or color negative image comprising:
imagewise exposing the silver halide motion picture film of claim 1 using a motion picture film recorder having a laser, LED, or CRT light source to provide an exposed film with a latent color positive or negative image.

15. The method of claim 14 comprising processing the exposed film with the latent color positive or color negative image to form a multicolor image wherein:
(a) the overall contrast for the images obtained from each of the blue light sensitive color record, the red light sensitive color record, and the green light sensitive color record is the slope of a straight line connecting a point A and a point B on the characteristic curve of Status A density vs. log Exposure (E) for the respective color record, wherein point A is the log Exposure (E) required to attain a density level of 0.4 above Dₘᵢₙ and point B is the point represented by the log Exposure (E) of point A plus 0.7 log Exposure (E),
(b) the overall contrast of the image obtained from the green light sensitive color record is at least 1 and up to and including 3.5,
(c) the overall contrast of the image obtained from the blue light sensitive color record and the overall contrast of the image obtained from the red light sensitive color record are the same or different and each is within ±12% of the overall contrast of the image obtained from the green light sensitive color record, and
(d) the Dₘₐₓ of the images obtainable from the three color records are the same or different and at least 2.3 in Status A density.

16. A motion picture film having a color positive image that is obtained from the method of claim 15, the motion picture film is provided as a film strip in either 16 or 35 mm format and having Bell and Howell perforations along each side of the film strip.

17. The motion picture film of claim 16 further comprising a digital or optical sound track.

18. The motion picture film of claim 16 further comprising calibration data for providing color patches.

19. The motion picture film of claim 16 having a multicolor image that is provided by an image in the green light sensitive color record that exhibits an overall contrast of at least 2 and up to and including 3, an image in the blue light sensitive color record that exhibits an overall contrast of at least 2 and up to and including 3, and an image in the red light sensitive color record that exhibits an overall contrast of at least 2 and up to and including 3, wherein the overall contrasts for the three images in the color records are independent of each other.

20. The motion picture film of claim 16 having a color image that exhibits dark stability at 10° C. greater than 20 years as determined by Arrhenius testing.

21. The motion picture film of claim 16 having a color image that exhibits dark stability at 10° C. greater than 50 years as determined by Arrhenius testing.
